(19) United States
(12) Patent Application Publication
(10) Pub. No.: US 2010/0217632 A1
(43) Pub. Date: Aug. 26, 2010

(54) MANAGING SERVICE ORIENTED ARCHITECTURE SHARED SERVICES ESCALATION

(75) Inventors: Kishore Channabasavaiah, Palatine, IL (US); Stephen C. Kendrick, Fairfax, VA (US); Sri Ramanathan, Lutz, FL (US); Mattew B. Trevathan, Kennesaw, GA (US); Raghu Varadan, San Francisco, CA (US); Nevenko Zunic, Hopewell Junction, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/391,362

(22) Filed: Feb. 24, 2009

(51) Int. Cl. G06Q 10/00; G06Q 50/00

(52) U.S. Cl. 705/7

(57) ABSTRACT

An approach that manages a service oriented architecture (SOA) shared service that fails to meet a set of objectives of the SOA shared service is provided. In one embodiment, there is a management tool, including an evaluation component configured to receive a SOA shared service that is developed as part of a potential SOA shared services project, and evaluate whether a set of objectives of the SOA shared service has been met; and a determination component configured to determine whether the SOA shared service should be developed in the case that the set of objectives of the SOA shared service has not been met.

### CROSS-REFERENCE TO RELATED APPLICATIONS

The present application is related in some aspects to commonly owned and co-pending application entitled “Identification of a Service Oriented Architecture Shared Services Project”, assigned attorney docket no. END920080252US1, which was filed on Nov. 24, 2008, and was assigned application Ser. No. 12/277,280, commonly owned and co-pending application entitled “Evaluating a Service Oriented Architecture Shared Service Project”, assigned attorney docket no. END920080288US1, which was filed on Feb. 19, 2009, and assigned application Ser. No. 12/388,533, commonly owned and co-pending application entitled “Selecting a Service Oriented Architecture Shared Service”, assigned attorney docket no. END920080289US1, which was filed on (to be provided), and was assigned application serial no. (to be provided), commonly owned and co-pending application entitled “Service Oriented Architecture Shared Services Elaboration”, assigned attorney docket no. END920080290US1, which was filed on (to be provided), and was assigned application serial no. (to be provided), commonly owned and co-pending application entitled “Constructing a Service Oriented Architecture Shared Service”, assigned attorney docket no. END920080291US1, which was filed on (to be provided), and was assigned application serial no. (to be provided), commonly owned and co-pending application entitled “Transitioning to Management of a Service Oriented Architecture Shared Service”, assigned attorney docket no. END920080292US1, which was filed on (to be provided), and was assigned application serial no. (to be provided), commonly owned and co-pending application entitled “Service Oriented Architecture Shared Service Management”, assigned attorney docket no. END920080293US1, which was filed on (to be provided), and was assigned application serial no. (to be provided), the entire contents of which are herein incorporated by reference.

### FIELD OF THE INVENTION

This invention relates generally to lifecycle management and more specifically to the evaluation and management of SOA shared services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

Current IT lifecycle processes are focused on managing self-contained and siloed solutions. However, as businesses transition to service oriented architectures (SOA), traditional IT governance methods are inadequate for managing SOA shared services during their entire lifecycle. SOA is not a self-contained and siloed solution. Rather it's a decomposition of solutions into a set of shared services. It is these SOA shared services that require a new lifecycle management system that takes into consideration multiple new processes that are not available or part of existing IT governance systems.

### SUMMARY OF THE INVENTION

In one embodiment, there is a method for managing a service oriented architecture (SOA) shared service that fails to meet a set of objectives of the SOA shared service. In this embodiment, the method comprises: receiving a SOA shared service that is developed as part of a potential SOA shared services project, and evaluating whether a set of objectives of the SOA shared service have been met; and determining whether the SOA shared service should be developed based on the evaluating.

In a second embodiment, there is a system for managing a service oriented architecture (SOA) shared service that fails to meet a set of objectives of the SOA shared service. In this embodiment, the system comprises at least one processing unit, and memory operably associated with the at least one processing unit. There is a management tool, including an evaluation component configured to receive a SOA shared service that is developed as part of a potential SOA shared services project, and evaluate whether a set of objectives of the SOA shared service has been met; and a determination component configured to determine whether the SOA shared service should be developed in the case that the set of objectives of the SOA shared service has not been met.

In a third embodiment, there is a computer-readable medium storing computer instructions, which when executed, enables a computer system to manage a service oriented architecture (SOA) shared service that fails to meet a set of objectives of the SOA shared service, the computer instructions comprising: receiving a SOA shared service that is developed as part of a potential SOA shared services project, and evaluating whether a set of objectives of the SOA shared service have been met; and determining whether the SOA shared service should be developed based on the evaluating.

In a fourth embodiment, there is a method for deploying a management tool for use in a computer system that provides management of a service oriented architecture (SOA) shared service that fails to meet a set of objectives of the SOA shared service. In this embodiment, a computer infrastructure is provided and is operable to: receive a SOA shared service that is developed as part of a potential SOA shared services project, and evaluate whether a set of objectives of the SOA shared service have been met; and determine whether the SOA shared service should be developed based on the evaluating.

### BRIEF DESCRIPTION OF THE DRAWINGS

FIG. 1 shows a schematic of an exemplary computing environment in which elements of the present invention may operate;

FIG. 2 shows a flow diagram of a SOA services lifecycle management process;

FIG. 3 shows a management tool that operates in the environment shown in FIG. 1; and

FIG. 4 shows a flow diagram of a SOA services lifecycle management process for exception and escalation of a SOA shared service.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to managing a service oriented architecture (SOA) shared service that fails to meet a set of objectives of the SOA shared service. In these embodiments, a management tool provides this capability. Specifically, the management tool comprises an evaluation component configured to receive a SOA shared service that is developed as part of a potential SOA shared services project, and evaluate whether a set of objectives of the SOA shared service has been met. A determination component is configured to determine whether the set of SOA shared services should be developed in the case that the set of objectives of the SOA shared service has not been met. The management tool identifies and resolves issues that occur during the SOA services lifecycle process in an expedient manner.

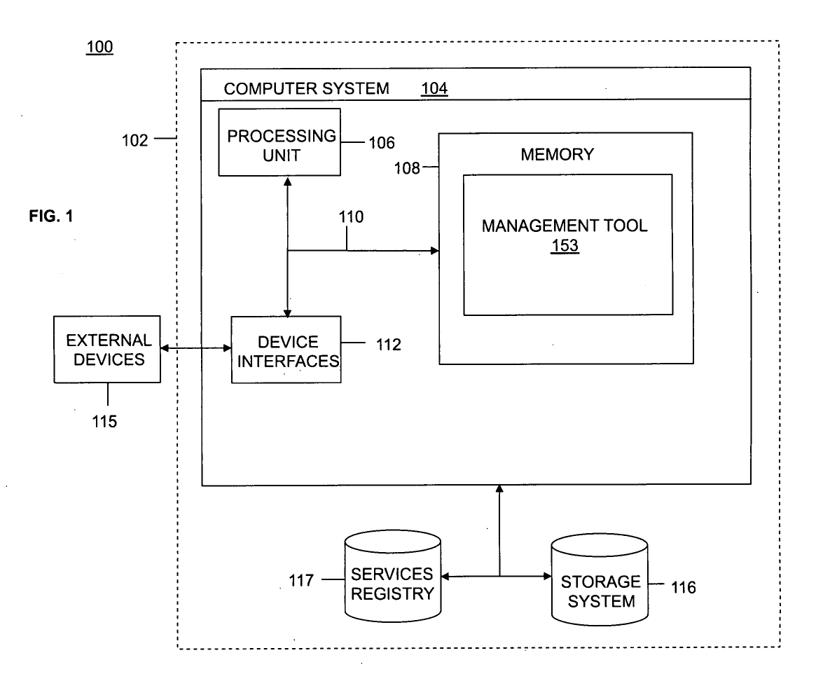

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for evaluating a SOA shared services project. It should be understood that any other computers implemented under the present invention may have different components/software, but will perform similar functions. As shown, computer system 104 includes a processing unit 106, memory 108 for storing a management tool 153, a bus 110, and device interfaces 112.

Processing unit 106, among other things, collects and routes signals representing outputs from external devices 115 (e.g., a keyboard, a pointing device, a display, a graphical user interface, etc.) to management tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating management tool 153, which is stored in memory 108 and/or storage system 116. While executing computer program code, processing unit 106 can read and/or write data to/from memory 108, storage system 116, and a services registry 117. Services registry 117 stores a plurality of services and associated metadata, as well as rules against which the metadata is compared to locate and store SOA shared services. Storage systems 116 and services registry 117 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

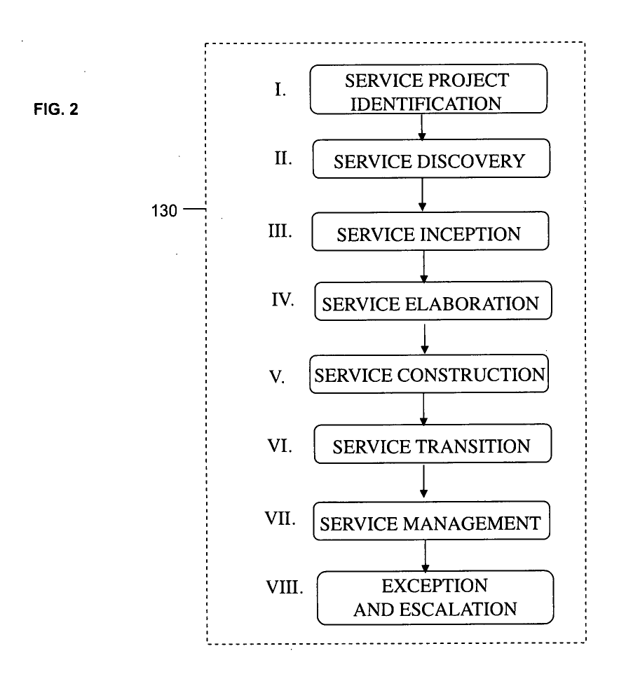

Implementation 100 and management tool 153 operate within a broader SOA services lifecycle management process (SLMP) 130, shown in FIG. 2, which identifies, evaluates, implements, and manages a SOA shared service. Specifically, SOA SLMP 130 of the present invention includes distinct roles, governance checkpoints, increased collaboration requirements, and decision control points. SOA SMLP 130 takes an extended view in identifying the various touch-points outside of the organization to plan, build and manage shared services. SOA SMLP 130 starts with the identification of a business initiative(s) (e.g., a business need) having the potential of being a shared service project candidate. The overall process ends with the rollout of shared services fulfilling the identified business initiative, as well as management across its entire life.

SOA SLMP 130 of the present invention consists of the following distinct processes and associated methodologies:
I. New Service Project Identification—the goal of this phase is to evaluate and identify a SOA shared services opportunity (i.e., a business need), and to determine if the SOA shared services opportunity can be met through the use of SOA shared services.
II. Service Discovery—the goal of this phase is to complete the Discovery phase for a project that has been identified as a potential SOA services candidate project.
III. Service Inception—the goal of this phase is to gather the high level requirements for the SOA shared services that will be developed as part of the potential SOA services candidate project.
IV. Service Elaboration—the goal of this phase is to further define the high level requirements from the Inception phase into detailed requirements to complete the service solution design and prepare for the build phase.
V. Service Construction—the goal of this phase is to develop the integration components and integrate the SOA shared services components per the design guidelines while meeting/exceeding the necessary quality requirements so that the services can be deployed for general use.
VI. Service Transition—the goal of this phase is to transition the SOA shared services developed in the Construction phase to the operations team that will be responsible for ongoing SOA shared service maintenance.
VII. Manage Services—the goal of this phase is to manage the SOA shared services once they have been transitioned to the operations team that will be responsible for ongoing SOA shared service maintenance.
VIII. Exception and Escalation—the goal of this phase, which is the focus of the present invention, is to resolve issues that occur during the management of the SOA services lifecycle process in an expedient manner.

Each of the above processes is a complete methodology that can be implemented independently since they define key stakeholders, affected processes, and touch-points throughout the organization. It will be appreciated that each of the above listed SOA processes are non-limiting examples of the functionality and operation of possible implementations of systems, methods and computer program products according to various embodiments of the present invention. In this regard, each process (I-VIII) may represent a module, segment, or portion of code, which comprises one or more executable instructions for implementing the specified logical function(s) of SOA SLMP 130, as shown in FIG. 2. It should also be noted that, in some alternative implementations, the functions noted in SOA SLMP 130 may occur out of the order listed above in processes I-VIII. For example, two processes shown in FIG. 2 in succession may, in fact, be executed substantially concurrently. It should also be noted that, in another alternative embodiment, additional or fewer process steps may be included in SOA SLMP 130. Further, each process of the flowchart of FIG. 2 can be implemented by special purpose hardware-based systems that perform the specified functions or acts, or combinations of special purpose hardware and computer instructions.

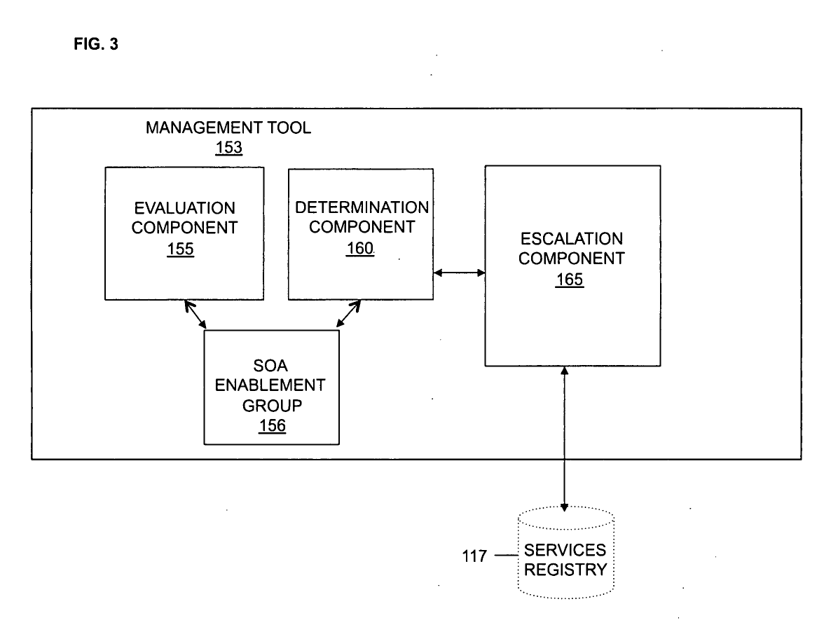

FIG. 3 shows a more detailed view of management tool 153 that manages a SOA shared service, which was established to address a SOA shared services opportunity (i.e., a business need). As shown, management tool 153 comprises an evaluation component 155 configured to receive the SOA shared service that is developed as part of a potential SOA shared services project, and evaluate whether a set of objectives of the SOA shared service has been met. In one embodiment, to accomplish this, input regarding the SOA shared service is provided to a SOA enablement group 156, for example, in the form of an exception request at an exception review meeting. The exception request may include virtually any information that assists SOA enablement group 156 to analyze the SOA shared service to identify whether the SOA shared service meets a set of objectives (i.e., technical or business alignments) for addressing the business need(s). Information is aggregated by SOA enablement group 156 and used as input to a determination component 160. It will be appreciated that SOA enablement group 156 described herein may represent a committee or group of individuals within an organization, or may represent a module, segment, or portion of code, which comprises one or more executable instructions for evaluating and managing the SOA shared service.

Next, a determination is made whether the SOA shared service should be considered for development in light of any issues that may have occurred during the SOA shared services lifecycle process. For example, although certain technical or business alignments have not been met by the SOA shared service, the SOA shared service may still have the potential to provide a business value. In one embodiment, management tool 153 comprises a determination component 160 configured to determine whether the set of SOA shared services should be developed in the case that the set of objectives of the SOA shared service has not been met. Determination component 160, along with SOA enablement group 156, determines whether to approve the exception request and develop the SOA shared service, or deny the request.

In one scenario, SOA enablement group 156 may determine that there is insufficient potential business value in developing the SOA shared service, and the exception request will be denied. In this case, it is still possible to develop the SOA shared service by submitting an escalation request to a governance authority (e.g., an escalation committee) that controls whether the set of SOA shared services should be developed in the case that the set of objectives of the SOA shared service has not been met. To accomplish this, management component 153 comprises an escalation component configured to create the escalation request in the case that a determination has been made that the SOA shared service should not be developed.

The escalation request generally contains any information useful to the governance authority for identifying and resolving escalations that occur following denial of an exception request. In one embodiment, the escalation request comprises at least one of the following: a description of the SOA shared service, an identity of an entity making a request for the SOA shared service, an identity of each of a set of owners of the SOA shared service, or input from SOA enablement group 156 regarding the SOA shared service (e.g., a denial of the exception request, reasons for the denial, etc.). In one embodiment, escalation component 165 is configured to automatically generate an escalation request in the case that a disagreement arises between the entity making the request for the SOA shared services and SOA enablement group 156. In another embodiment, escalation component 165 is configured to automatically generate an escalation request in the case that the owner of the SOA shared service fails to implement the SOA shared service, i.e., fails to accept ownership and/or fails to carry out the SOA shared services project.

Once the SOA shared service and the escalation request are analyzed, it is determined whether the SOA shared service should proceed to development even though the initial objective(s) of the SOA shared service has not been met. Specifically, escalation component 165 reviews the analysis performed by determination component 160 and SOA enablement group 156, along with any funding allocation analysis, and either grants or denies the escalation request. If approval is granted, and the SOA shared service moves to development, escalation component 165 enters meta-data of the SOA shared service into services registry 117, and assigns a status indicator (e.g., “Escalation Request Approved”).

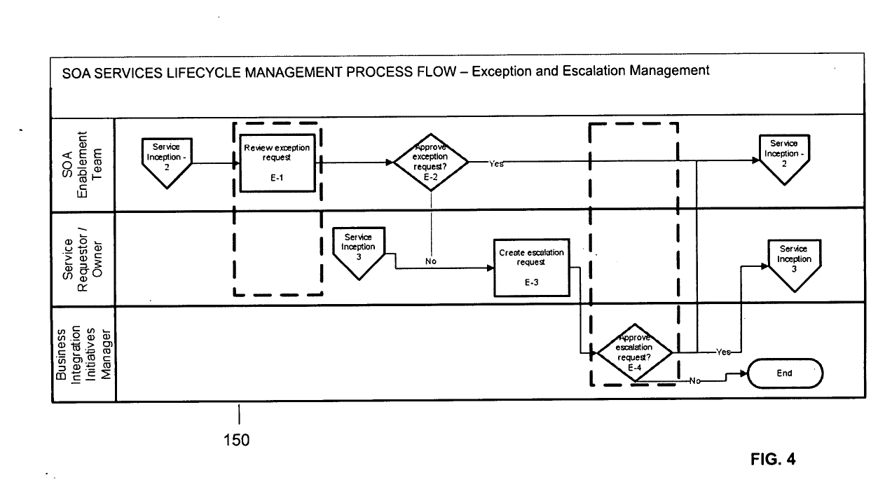

Referring now to FIG. 4, a SOA services lifecycle management process (SLMP) flow 150 for managing exception and escalation of a SOA shared service will be described in further detail. As shown, SOA SLMP flow 150 first receives an exception request, including a SOA shared service that is developed as part of a potential SOA shared services project, and evaluates whether a set of objectives of the SOA shared service has been met at exception/escalation-1 (E-1). Then at E-2, analysis continues with the determination of whether the SOA shared service should be developed in the case that the set of objectives of the SOA shared service has not been met. At E-3, if the exception request is denied, an escalation request is created to appeal the decision at E-2. The escalation request comprises an appeal to the governance authority that controls whether the SOA shared service should be developed in the case that the set of objectives of the SOA shared service has not been met. At E-4, a determination is made whether the escalation request is to be approved or denied. If approval is received, the SOA shared service is developed. If approval is denied, the SOA shared service is not developed, and SLMP 150 flow repeats for a new SOA shared service.

As shown, FIG. 4 details the organizational roles and responsibilities for each entity in SOA SLMP flow 150. Specifically, SOA SLMP flow 150 identifies shared service roles indicating the primary and secondary (if applicable) roles for each entity (i.e., Business Integration Initiatives Manager, Service Requester/Owner, and SOA Enablement Team) at each process of the potential SOA shared services project. For example, at E-1, the SOA enablement team is considered to have primary responsibility for reviewing the exception request. The service requester is considered to have secondary responsibility. This may mean that the SOA enablement team is given authority and accountability to make the initial review of the exception request at E-1. In this regard, SOA SLMP flow 150 governs the rules of engagement between the various entities. SOA SLMP flow 150 provides integration points between the various entities across different organizational domains involved in the development, integration, deployment and management of SOA shared services, as discussed herein.

It will be appreciated that SOA SLMP flow 150 of FIG. 4 represents one possible implementation of a process flow for managing a SOA shared service that fails to meet a set of objectives of the SOA shared service. SOA SLMP flow 150 illustrates the architecture, functionality, and operation of possible implementations of systems, methods and computer program products according to various embodiments of the present invention. In this regard, each portion of the flowchart may represent a module, segment, or portion of code, which comprises one or more executable instructions for implementing the specified logical function(s). It will also be noted that each block of flowchart illustration can be implemented by special purpose hardware-based systems that perform the specified functions or acts, or combinations of special purpose hardware and computer instructions.

Further, it can be appreciated that the methodologies disclosed herein can be used within a computer system to provide management of a SOA shared service that fails to meet a set of objectives of the SOA shared service, as shown in FIG. 1. In this case, management tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for managing a SOA shared service that fails to meet a set of objectives of the SOA shared service. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for managing a service oriented architecture (SOA) shared service that fails to meet a set of objectives of the SOA shared service, the method comprising:
receiving a SOA shared service that is developed as part of a potential SOA shared services project;
evaluating whether a set of objectives of the SOA shared service has been met; and
determining whether the SOA shared service should be developed based on the evaluating.

2. The method according to claim 1 further comprising creating an escalation request in the case that a determination has been made that the SOA shared service should not be developed, wherein the escalation request comprises an appeal to a governance authority that controls whether the set of SOA shared services should be developed in the case that the set of objectives of the SOA shared service has not been met.

3. The method according to claim 2, the escalation request further comprising at least one of the following: a description of the SOA shared service, an identity of an entity making a request for the SOA shared service, an identity of each of a set of owners of the SOA shared service, or input from a SOA enablement group regarding the SOA shared service.

4. The method according to claim 3, wherein the escalation request is generated automatically in the case that a disagreement arises between the entity making the request for the SOA shared service and the SOA enablement group.

5. The method according to claim 3, wherein the escalation request is generated automatically in the case that the owner of the SOA shared service fails to implement the SOA shared service.

6. A system for managing a service oriented architecture (SOA) shared service that fails to meet a set of objectives of the SOA shared service, the system comprising:
at least one processing unit;
memory operably associated with the at least one processing unit; and
a management tool storable in memory and executable by the at least one processing unit, the management tool comprising:
an evaluation component configured to:
receive a SOA shared service that is developed as part of a potential SOA shared services project;
evaluate whether a set of objectives of the SOA shared service has been met; and
a determination component configured to determine whether the SOA shared service should be developed in the case that the set of objectives of the SOA shared service has not been met.

7. The management tool according to claim 6 further comprising an escalation component configured to create an escalation request in the case that a determination has been made that the SOA shared service should not be developed, wherein the escalation request comprises an appeal to a governance authority that controls whether the SOA shared service should be developed in the case that the set of objectives of the SOA shared service has not been met.

8. The management tool according to claim 7, the escalation request further comprising at least one of the following: a description of the SOA shared service, an identity of an entity making a request for the SOA shared service, an identity of each of a set of owners of the SOA shared service, or input from a SOA enablement group regarding the SOA shared service.

9. The management tool according to claim 8, the escalation component further configured to automatically generate the escalation request in the case that a disagreement arises between the entity making the request for the SOA shared service and the SOA enablement group.

10. The method according to claim 8, the escalation component further configured to automatically generate the escalation request in the case that the owner of the SOA shared service fails to implement the SOA shared service.

11. A computer-readable medium storing computer instructions, which when executed, enables a computer system to manage a service oriented architecture (SOA) shared service that fails to meet a set of objectives of the SOA shared service, the computer instructions comprising:
receiving a SOA shared service that is developed as part of a potential SOA shared services project;
evaluating whether a set of objectives of the SOA shared service has been met; and
determining whether the SOA shared service should be developed based on the evaluating.

12. The computer-readable medium according to claim 11 further comprising instructions for creating an escalation request in the case that a determination has been made that the SOA shared service should not be developed, wherein the escalation request comprises an appeal to a governance authority that controls whether the set of SOA shared services should be developed in the case that the set of objectives of the SOA shared service has not been met.

13. The computer-readable medium according to claim 12, the escalation request further comprising at least one of the following: a description of the SOA shared service, an identity of an entity making a request for the SOA shared service, an identity of each of a set of owners of the SOA shared service, or input from a SOA enablement group regarding the SOA shared service.

14. The computer-readable medium according to claim 13 further comprising computer instructions for automatically generating the escalation request in the case that a disagreement arises between the entity making the request for the SOA shared service and the SOA enablement group.

15. The computer-readable medium according to claim 13 further comprising computer instructions for automatically generating the escalation request in the case that the owner of the SOA shared service fails to implement the SOA shared service.

16. A method for deploying a management tool for use in a computer system that provides management of a service oriented architecture (SOA) shared service that fails to meet a set of objectives of the SOA shared service, comprising:
providing a computer infrastructure operable to:
receive a SOA shared service that is developed as part of a potential SOA shared services project;
evaluate whether a set of objectives of the SOA shared service has been met; and
determine whether the SOA shared service should be developed based on the evaluating.

17. The method according to claim 16, the computer infrastructure further operable to create an escalation request in the case that a determination has been made that the SOA shared service should not be developed, wherein the escalation request comprises an appeal to a governance authority that controls whether the set of SOA shared services should be developed in the case that the set of objectives of the SOA shared service has not been met.

18. The method according to claim 17, the escalation request further comprising at least one of the following: a description of the SOA shared service, an identity of an entity making a request for the SOA shared service, an identity of each of a set of owners of the SOA shared service, or input from a SOA enablement group regarding the SOA shared service.

19. The method according to claim 18, the computer infrastructure operable to create an escalation request further operable to automatically generate the escalation request in the case that a disagreement arises between the entity making the request for the SOA shared service and the SOA enablement group.

20. The method according to claim 18, the computer infrastructure operable to create an escalation request further operable to automatically generate the escalation request in the case that the owner of the SOA shared service fails to implement the SOA shared service.
